(19) United States
(12) Patent Application Publication
(10) Pub. No.: US 2011/0175992 A1
(43) Pub. Date: Jul. 21, 2011

(54) FILE SELECTION SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/789,296

(22) Filed: May 27, 2010

(30) Foreign Application Priority Data
Jan. 20, 2010 (CN) 201010300503.2

(51) Int. Cl. H04N 7/18

(52) U.S. Cl. 348/78; 348/E07.085

(57) ABSTRACT

A file selection system includes a display unit, a camera, and a processing unit. The camera captures an image. The processing unit examines the image to find a face, eyeballs, and eye sockets, and determining a location of the face in the image and a location of an eyeball in an eye socket, to obtain which area an individual looks at. The processing unit further selects media content according to the area the individual looks at. The display unit displays the selected media content.

### CROSS-REFERENCE TO RELATED APPLICATIONS

Relevant subject matter is disclosed in one co-pending U.S. patent application (Attorney Docket No. US28710, application Ser. No. 12/760,420), which is assigned to the same assignee as this patent application.

### BACKGROUND

1. Technical Field

The present disclosure relates to a file selection system and a file selection method.

2. Description of Related Art

Outdoor media, such as electronic billboards may advertise various goods and services to the public. However, most of these electronic billboards are not interactive and only statically show a particular advertisement for a particular period of time. For large billboards only one advertisement may be displayed at any particular time. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of a first embodiment of a file selection system including an electronic billboard and a storage system.

FIG. 2 is a block diagram of the storage system of FIG. 1.

FIGS. 3 and 4 are schematic diagrams of an individual viewing the electronic billboard of FIG. 1.

FIG. 5 is a block diagram of a second embodiment of a file selection system.

FIG. 6 is a block diagram of a third embodiment of a file selection system.

FIG. 7 is a flowchart of an exemplary embodiment of a file selection method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

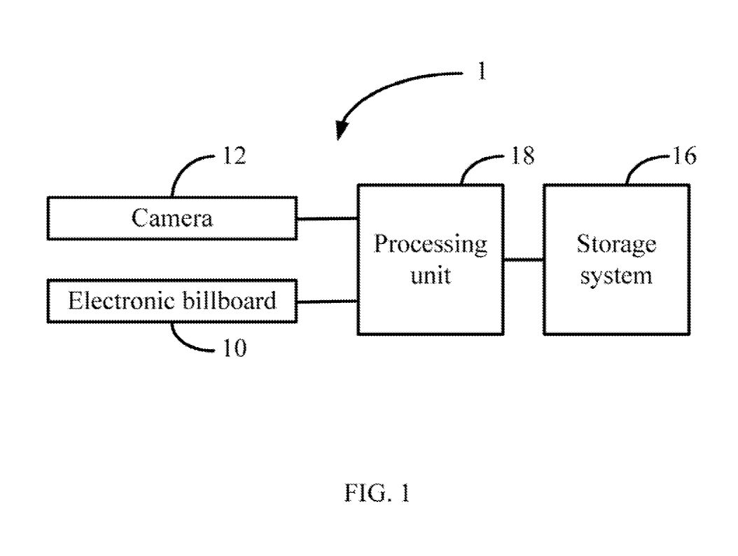

Referring to FIG. 1, a first embodiment of a file selection system 1 includes a display unit, such as an electronic billboard 10, a camera 12, a processing unit 16, and a storage system 18. The file selection system 1 is operable to select different media files when an individual looks at different areas of the electronic billboard 10. The electronic billboard 10 displays media files selected by the file selection system 1.

The camera 12 is disposed on the electronic billboard 10 to capture images of the immediate area. The images of the immediate area may comprise an audience of one or more individuals viewing the electronic billboard 10.

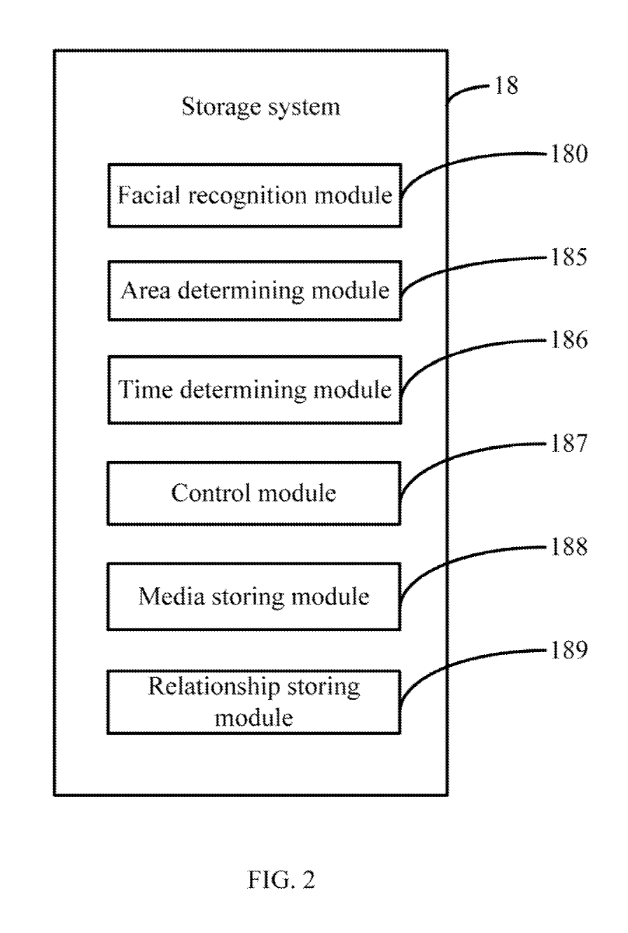

Referring to FIG. 2, the storage system 18 includes a facial recognition module 180, an area determining module 185, a time determining module 186, a control module 187, a media storing module 188, and a relationship storing module 189. The facial recognition module 180, the area determining module 185, the time determining module 186, and the control module 187 may include one or more computerized instructions and are executed by the processing unit 16.

The facial recognition module 180 examines the image from the camera 12 to find faces. The facial recognition module 180 further examines the found faces to find eyeballs and corresponding eye sockets in the found faces. It can be understood that the facial recognition module 180 uses well known facial recognition technology to find the faces, the eyeballs, and the corresponding eye sockets.

The area determining module 185 determines a location of the face in the image and a location of an eyeball in a corresponding eye socket of the face to find a gazing direction of the individual. In other words, the area determining module 185 obtains which area the individual looks at.

The time determining module 186 records the period or length of time an individual looks at an area of the electronic billboard 10. In the embodiment, the time determining module 186 starts to time when the individual begins to look at an area of the electronic billboard 10, and stops timing when the individual begins to look at another area of the electronic billboard 10. As a result, the time determining module 186 can calculate the length of time the individual looks at an area of the electronic billboard 10.

The media storing module 188 stores a plurality of different media content, such as advertisements for a first product and a second product.

The relationship storing module 189 stores a plurality of relationships between the different areas the eyes look at and the different media content. For example, advertisements for the first product may correspond to a first area the eyes look at. Advertisements for the second product may correspond to a second area the eyes look at.

The control module 187 determines whether the individual is interested in the area according to the time from the time determining module 186. Upon the condition that the individual is interested in the area, the control module 187 selects the media content according to the area, and transmits the selected media content to the electronic billboard 10. The electronic billboard 10 displays the media content in the media storing module 188 according to the control module 187.

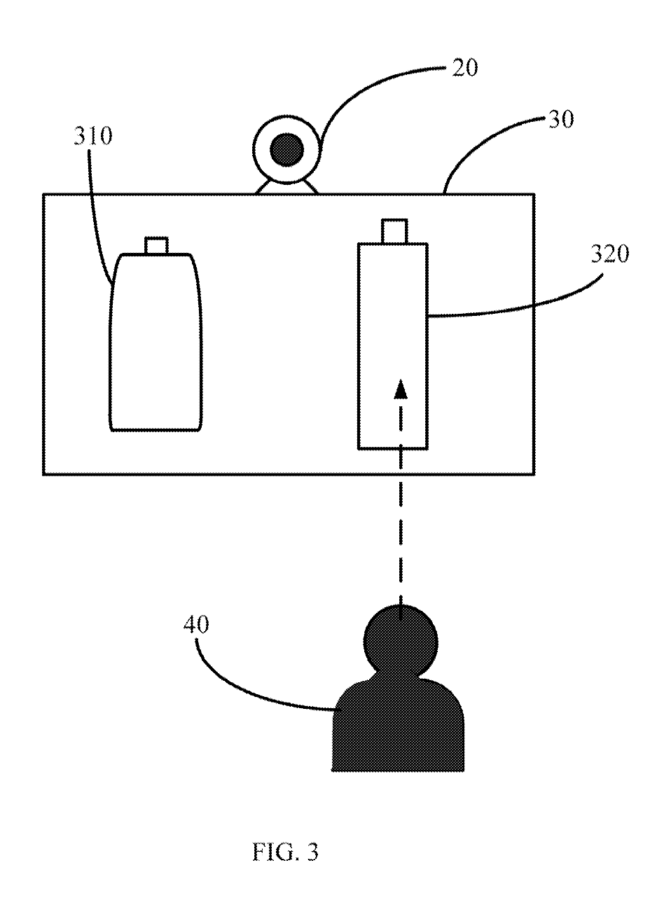

Referring to FIG. 3, the electronic billboard 10 displays two types of products. A first product 310 is displayed on a left side of the electronic billboard 10, which is called a first area. A second product 320 is displayed on a right side of the electronic billboard 10, which is called a second area. The media storing module 188 (FIG. 2) stores advertisements for the first product 310 and the second product 320. The advertisements for the first product 310 correspond to the first area. The advertisements for the second product 320 correspond to the second area.

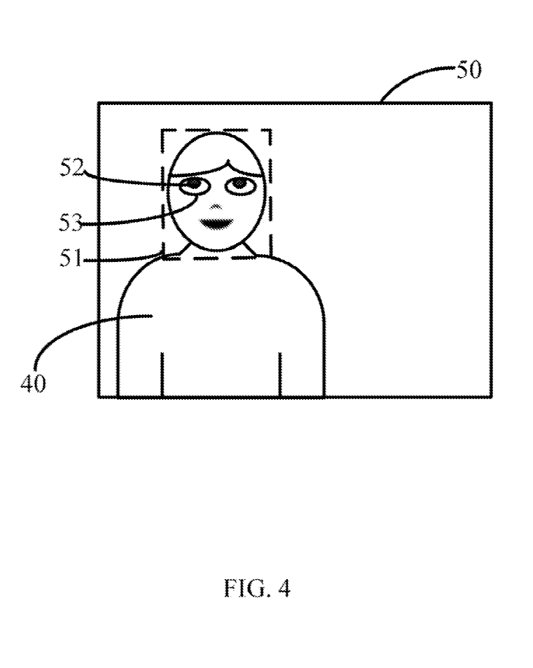

Referring to FIG. 4, the camera 12 captures an image 50 of the immediate area. The image 50 comprises an individual 40 who is viewing the electronic billboard 10. The image 50 is transmitted to the facial recognition module 180. The facial recognition module 180 locates a face 51, two eyeballs 52, and two eye sockets 53 in the image 50. The area determining module 185 finds the face 51 is on the left side of the image 50, and each eyeball 52 is in the middle of the eye socket 53, thus determines the face 51 of the individual 40 is directed towards the right area of the electronic billboard 10, namely the second area. According to the time determining module 186, it is known that the individual 40 is interested in the second area.

The control module 187 selects the advertisements for the second product 320 correspondingly. The selected media content is displayed by the electronic billboard 10.

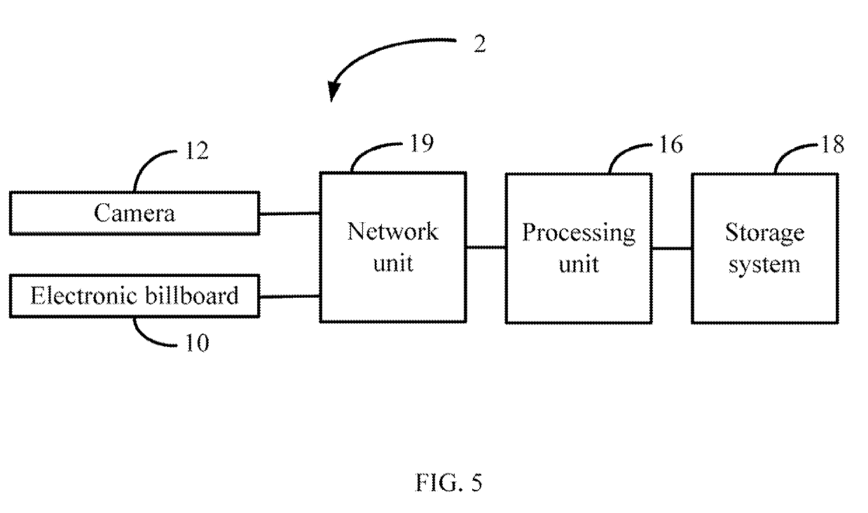

Referring to FIG. 5, a second embodiment of a file selection system 2 includes an electronic billboard 10, a camera 12, a processing unit 16, a storage system 18, and a network unit 19. The electronic billboard 10, the camera 12, the processing unit 16, and the storage system 18 are the same with the first embodiment. The network unit 19 is connected between the camera 12 and the electronic billboard 10, and the processing unit 16, to transmit images between the storage system 18 and the camera 12, and media content between the storage system 18 and the electronic billboard 10.

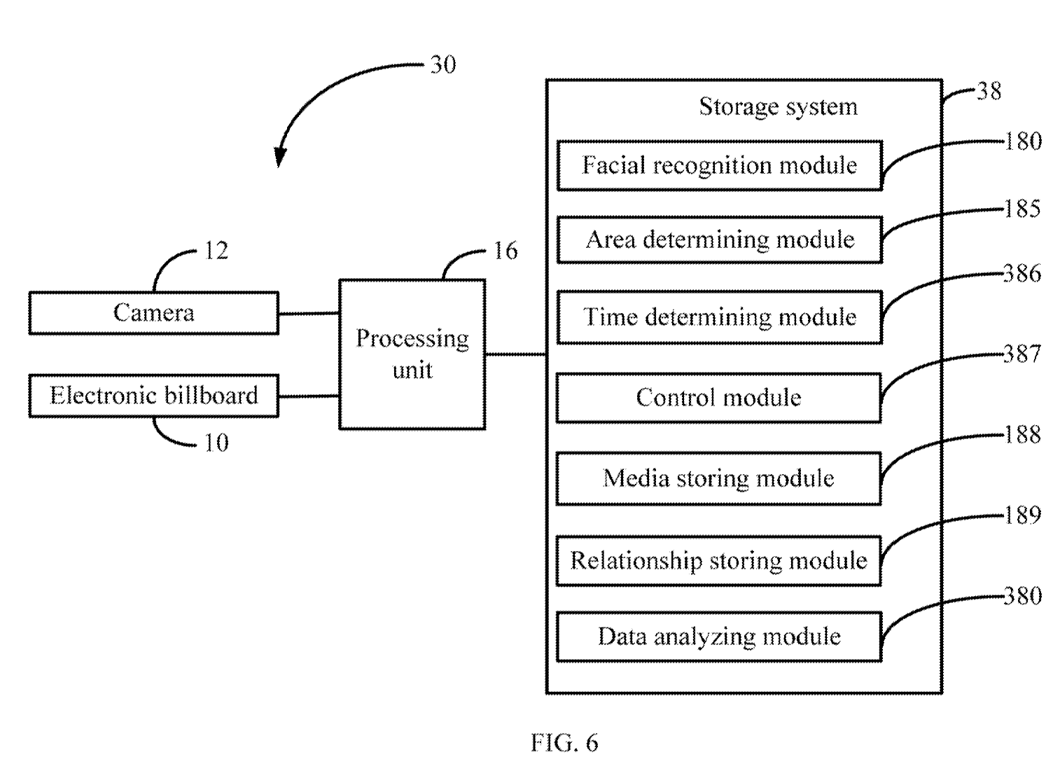

Referring to FIG. 6, a third embodiment of a file selection system 3 includes an electronic billboard 10, a camera 12, a processing unit 16, and a storage system 38. The electronic billboard 10, the camera 12, and the processing unit 16 are the same as the first embodiment.

The storage system 38 includes a facial recognition module 180, an area determining module 185, a time determining module 386, a control module 387, a media storing module 188, a relationship storing module 189, and a data analyzing module 380. The facial recognition module 180, the area determining module 185, the media storing module 188 and the relationship storing module 189 are the same as the first embodiment. The time determining module 386 records the period or length of time an individual looks at each area of the electronic billboard 10. The data analyzing module 380 calculates a length of time the individual looks at each area of the electronic billboard 10 to know which area the individual is interested in. For example, the data analyzing module 380 calculates a first time the face being directed towards the first area of the electronic billboard 10 is one second, and a second time the face being directed towards the second area of the electronic billboard 10 is five seconds. As a result, the control module 387 determines the individual is interested in the second area because the second time is longer than the first time, and selects corresponding media content. The electronic billboard 10 displays the media content.

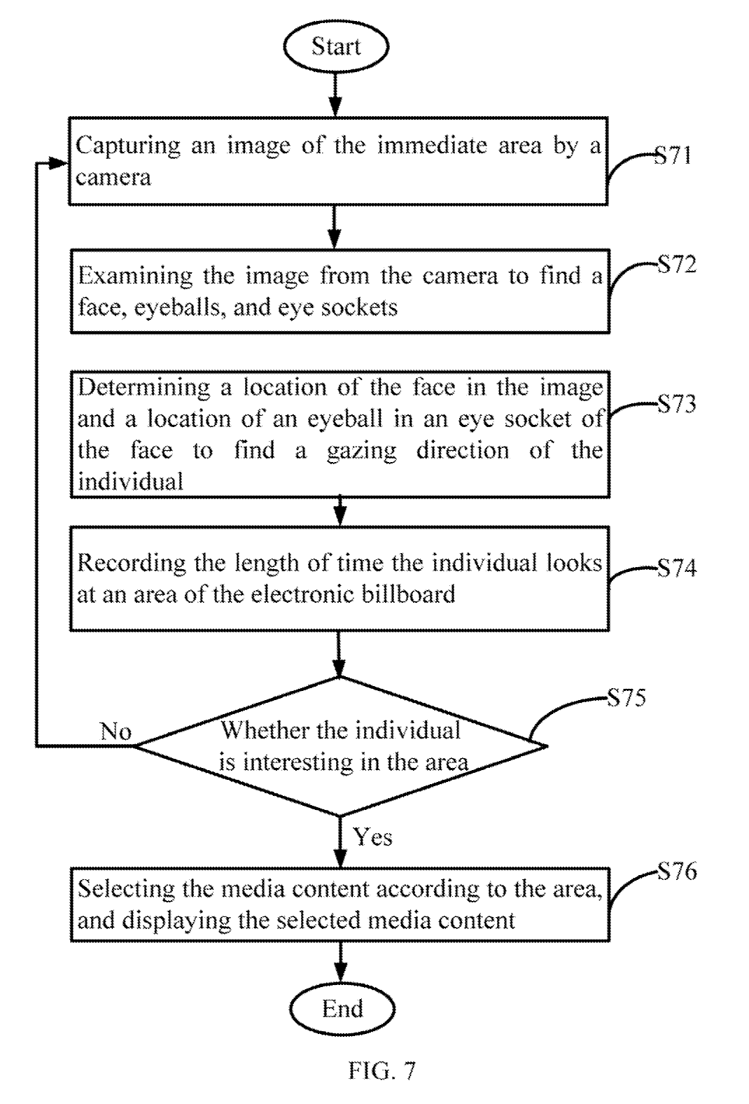

Referring to FIG. 7, an exemplary embodiment of a file selection method includes the following steps.

In step S71, the camera 12 captures an image of the immediate area.

In step S72, the facial recognition module 180 examines the image from the camera 12 to find a face, eyeballs, and eye sockets. It can be understood that the facial recognition module 180 uses well known facial recognition technology to find the face, the eyeballs, and the eye sockets.

In step S73, the area determining module 185 determines a location of the face in the image and a location of an eyeball in an eye socket of the face to find a gazing direction of the individual. In other words, the area determining module 185 obtains which area the individual is looking at.

In step S74, the time determining module 186 records the period or length of time the individual looks at an area of the electronic billboard 10. In the embodiment, the time determining module 186 starts to time when the individual begins to look at an area of the electronic billboard 10, and stops timing when the individual begins to look at another area of the electronic billboard 10. As a result, the time determining module 186 can calculate the length of time the individual looks at an area of the electronic billboard 10.

In step S75, the control module 187 determines whether the individual is interested in the area according to the length of time from the time determining module 186.

In step S76, upon the condition that the individual is interested in the area, the control module 187 selects the media content according to the area, and transmits the selected media content to the electronic billboard 10. The electronic billboard 10 displays the media content in the media storing module 188 according to the control module 187.

Upon the condition that the individual is not interested in the area, the process returns to the step S71.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A file selection system comprising:
a camera to capture an image;
a display unit;
a processing unit connected to the camera and the display unit; and
a storage system connected to the processing unit and storing a plurality of programs to be executed by the processing unit, wherein the storage system comprises:
a facial recognition module to examine the image from the camera to find a face, eyeballs, and eye sockets in the image;
an area determining module to determine a location of the face in the image and a location of each eyeball in a corresponding eye socket of the face to find a gazing direction of the individual, to obtain which area the individual looks at;
a storing module storing a plurality of different media contents and a plurality of relationships between different areas the individual looks at and the different media contents;
a time determining module to record the length of time the individual looks at the area; and
a control module to determine whether the individual is interested in the area according to the period of time from the time determining module, and select the media content correspondingly upon the condition that the individual is interested in the area, thereby displaying the selected media content by the display unit.

2. The file selection system of claim 1, further comprising a network unit to transmit the images between the storage system and the camera, and transmit the media contents between the storage system and the display unit.

3. The file selection system of claim 1, wherein the display unit is an electronic billboard.

4. A file selection system comprising:
a camera to capture an image;
a display unit;
a processing unit connected to the camera and the display unit; and
a storage system connected to the processing unit and storing a plurality of programs to be executed by the processing unit, wherein the storage system comprises:
a facial recognition module to examine the image from the camera to find a face, an eyeball, and a corresponding eye socket in the image;
an area determining module to determine a location of the face in the image and a location of the eyeball in the eye socket of the face to find a gazing direction of the individual, to obtain which area the individual looks at;
a storing module to store a plurality of different media contents and a plurality of relationships between different areas the individual looks at and the different media contents;
a time determining module to record the length of time the individual looks at each area;
a data analyzing module to calculate the length of time the individual looks at each area of the display unit; and
a control module to determine in which area the individual is interested according to the length of times for all areas from the data analyzing module, and select the media content correspondingly, thereby displaying the selected media content by the display unit.

5. The file selection system of claim 4, further comprising a network unit to transmit the images between the storage system and the camera, and transmit the media content between the storage system and the display unit.

6. The file selection system of claim 4, wherein the display unit is an electronic billboard.

7. A file selection method comprising:
capturing an image by a camera;
examining the image from the camera to find a face, an eyeball, and a corresponding eye socket;
determining a location of the face in the image and a location of the eyeball in the eye socket, to obtain which area the individual looks at;
selecting media content according to the area the individual looks at; and
displaying the selected media content by the display unit.

8. The file selection method of claim 7, after the step of “determining a location of the face in the image and a location of the eyeball in the eye socket, to obtain which area the individual looks at”, further comprising:
calculating the length of time the individual looks at an area of the display unit; and
determining whether the individual is interested in the area;
wherein upon the condition that the individual is interested in the area, the step of “selecting media content according to the area the individual looks at” is executed.

9. The file selection method of claim 7, after the step of “determining a location of the face in the image and a location of the eyeball in the eye socket, to obtain which area the individual looks at”, further comprising:
calculating the length of time the individual looks at an area of the display unit; and
determining whether the individual is interested in the area;
wherein upon the condition that the individual is not interested in the area, the step of “capturing an image by a camera” is executed.

10. The file selection method of claim 7, after the step of “determining a location of the face in the image and a location of the eyeball in the eyebit, to obtain which area the individual looks at”, further comprising:
calculating the length of time the individual looks at each area of the display unit; and
determining which area the individual is interested in.

11. The file selection method of claim 7, wherein the display unit is an electronic billboard.
